(19) United States
(12) Patent Application Publication
(10) Pub. No.: US 2006/0039943 A1
(43) Pub. Date: Feb. 23, 2006

(54) Acetyl-CoA carboxylase inhibitors for use as pesticides

(75) Inventors: Shalom W. Applebaum, Rehovot (IL); Baruch Rubin, Mazkeret Batya (IL); Ada Rafaeli, Ness Ziona (IL)

Correspondence Address: BROWDY AND NEIMARK, P.L.L.C.;624 NINTH STREET, NW, SUITE 300, WASHINGTON, DC, 20001-5303, US

(73) Assignees: Yissum Research Development Company fo the Hebrew University, Jerusalem (IL); State of Israel, Ministry of Agriculture & Rural Devp., Agr. Research Org (A.R.O.), Volcani Center, Bet Dagan (IL)

(21) Appl. No.: 11/175,038

(22) Filed: Jul. 6, 2005

Related U.S. Application Data
(63) Continuation-in-part of application No. PCT/IL04/00002, filed on Jan. 5, 2004.
(60) Provisional application No. 60/421,117, filed on Jan. 6, 2003.

(51) Int. Cl. A01N 25/00; A01N 37/10; A01N 33/24

(52) U.S. Cl. 424/405; 514/571; 514/640

(57) ABSTRACT

The present invention relates to the use of inhibitors of the action of eukaryotic-type Acetyl-CoA carboxylase for controlling insect pests. The inhibitors are selected from arylphenoxypropionates and cyclohexanedione oximes, or their mixtures which may be used together with suitable additives, excipients and carriers. The invention further relates to an insecticidal composition comprising inhibitors of eukaryotic-type Acetyl-CoA carboxylase and further to a method for controlling undesired insect pests by applying an effective amount of eukaryotic-type Acetyl-CoA carboxylase inhibitors.

### CROSS REFERENCE TO RELATED APPLICATIONS

The present application is a continuation-in-part of International Application No. PCT/IL2004/000002, filed Jan. 5, 2004, which claims priority of U.S. Provisional Application No. 60/421,117, filed Jan. 6, 2003. The entire contents of both applications being hereby incorporated herein by reference.

### FIELD OF THE INVENTION

This invention relates to a method, use and composition for controlling pests, more specifically insects.

### BACKGROUND OF THE INVENTION

The following are publications describing relevant prior art.
1. Rafaeli, A. Neuroendocrine control of pheromone biosynthesis in moths. Int. Rev. Cytology 213, 49-92 (2001).
2. Sasaki, Y., Konishi, T., and Nagano, Y. The compartmentation of acetyl-coenzyme A carboxylase in plants. Plant Physiol. 108, 445-449 (1995).
3. Kemal, C. and Casida, J. E. Coenzyme A esters of 2-aryloxyphenoxypropionate herbicides and 2-arylpropionate antiinflammatory drugs are potent and stereoselective inhibitors of rat liver acetyl-CoA carboxylase. Life Sci. 50, 533-540 (1992).
4. Goldring, J. P. and Read, J. S. Insect acetyl-CoA carboxylase: enzyme activity during the larval, pupal and adult stages of insect development. Comp. Biochem. and Physiol. B 106, 855-858 (1993).
5. Franz J. M., Bogenschutz, H., Hassan. S. A., Huang, P., Naton, E., Suter, H. and Viggiani, G. Results of a joint pesticide test programme by the working group: pesticides and beneficial arthropods. Entomophaga 23, 231-236 (1980).
6. Tillman, J. A., Seybold, S. J., Jurenka, R. A., Blomquist, G. J. Insect pheromones—an overview of biosynthesis and endocrine regulation. Insect Biochem. Mol. Biol. 29, 481-514 (1999).
7. Rafaeli, A. and Gileadi, C. Modulation of the PBAN-induced pheromonotropic activity in Helicoverpa armigera. Insect Biochem. Molec. Biol. 25, 827-834 (1995).
8. Rafaeli, A., Soroker, V. Influence of diel rhythm and brain hormone on hormone production in two Lepidopteran species. J. Chem. Ecol. 15, 447-455 (1989).
9. Soroker, V. and Rafaeli, A. In vitro hormonal stimulation of ¹⁴C acetate incorporation by Heliothis armigera pheromone glands. Insect Biochem. 19, 1-15 (1989).
10. Dunkelblum, E., Gothilf, S., Kehat, M. Identification of the sex pheromoe of the cotton bollworm, Heliothis armigera, in Israel. Phytoparasitica 8, 209-211 (1980).
11. Eliyahu, D., Applebaum, S. W., Rafaeli, A, Moth sex-pheromone biosynthesis is inhibited by the herbicide, Diclofop. Pestic. Biochem. Physiol 77 75-81 (2003).

Herbicides and plant growth regulators may be classified by their mode of action, i.e. by the specific target in the synthetic pathway, in the desired plant they are aimed to inhibit or control. Such specific targets may be, for example, seed germination (dinitoanilines), branched chain amino acid synthesis (ALS or AHAS) such as the sulfonylureas and imidazolinones, lipid synthesis (Esprocarb), cell division inhibitor (chloroacetamide) etc. Herbicides or their metabolic intermediates, as many other synthetic moieties, may be toxic to other taxa of living organisms. These chemical moieties may accumulate and disturb the life cycle of such organism's. However, the differences between the metabolic and growth systems of plants and those of insects, fungi and mammals render many of the herbicides as non-toxic to immediate growth and development of such organisms.

### SUMMARY OF THE INVENTION

The present invention is based on the finding that inhibitors of eukaryotic-type Acetyl-CoA carboxylase in the chloroplast of certain plants, may inhibit specific Acetyl-CoA carboxylase function in insects. Specifically, this inhibition suppresses biosynthetic pathways regulating female sex pheromone synthesis, thus leading to mating disruption and hence disruption of reproductive behavior in such insects in which female sex pheromones are fatty acid derivatives.

Without meaning in any way to be bound by theory, the inhibition in the production of species-specific female sex pheromone, may give rise to female non-receptivity and consequently disorientation of the male of that species. This in turn may decrease mating frequency, thus leading to a decrease in the insect population.

Thus, Acetyl Co-A carboxylase inhibitors and in particular such inhibitors that are known or used as herbicides, are used, in accordance with the invention, as agents for controlling insects or insect infestation. Use of said inhibitors may be made, for example, in controlling insects in agriculture, domestic use, in industry, etc.

The term “controlling insects” is meant to denote an act that will give rise to a decrease in the number of the insects as compared to the numbers without such act. Insect control may denote decrease in an insect population, inhibition of increase in number of an insect population, reducing the rate of increase in number of an insect population or increase in the rate of decrease in an insect population. The control may at times give rise to an almost complete eradication of an insect population or at other times maintaining insect population at a low level.

Prior to the present invention, Acetyl-CoA carboxylase inhibitors and particularly such used as herbicides were considered to be non-toxic and even to be beneficial to insects⁵.

The present invention further concerns a method for reducing population of insects in a treatment location by applying to the location an effective amount of at least one inhibitor of eukaryotic-type Acetyl-CoA carboxylase.

The present invention still further concerns an insecticidal composition comprising inhibitors of eukaryotic-type Acetyl-CoA carboxylase optionally together with a suitable carrier, excipient or diluent.

In accordance with a preferred embodiment, the insecticidal composition of the invention further comprises at least one insect attracting agent.

Examples of eukaryotic-type Acetyl-CoA carboxylase inhibitors that may be used in accordance with the invention include aryloxyphenoxy propionates in free acid form, ester form or salt form and cyclohexandione oximes or salts thereof or mixtures of aryloxyphenoxy propionate and cyclohexandione oxime.

The aryloxyphenoxy propionates may, for example, be one or more of the group that includes: clodinafop-propargyl, clodinafop, cyhalofop-butyl, cyhalofop, diclofop-methyl, diclofop, fenoxaprop-P-ethyl, fenoxaprop, fluazifop-butyl, fluazifop-P-butyl, fluazifop, haloxyfop, propaquizafop, quizalofop, quizalofop-P or their mixtures. The cyclohexandione oximes areselected from the group consisting of alloxydim, BAS 625 H, butroxydim, clethodim, cycloxydim, sethoxydim, tepraloxydim, tralkoxydim or their mixtures

Preferred arylphenoxy propionates are diclofop acid or diclofop-methyl; a preferred cyclohexanedione oxime is tralkoxydim.

The insects are typically such where the females produce sex-pheromones that are fatty acid derivatives. Examples of insects that fall into this category are from the order Lepidoptera. Representative examples of major insect pests in agriculture of this order include insects from the Noctuidae moth family, particularly such belonging to the genera Helicoverpa, Heliothis, Spodoptera. Another representative moth pest of Stored Products is from the genus Plodia Another example is the Codling moth (Cydia pomonella), a major pest of some orchard crops. A more exhaustive list of Lepidopteran female insects producing sex pheromones that are derived from fatty acids (precursors of the pheromones) can be found in the “Pherolist”: http://www-pherolist.slu.se/pherolist.php. Examples of insects where the female sex-pheromones are fatty acid derivatives, not belonging to the Lepidoptera: the housefly (Musca domestica), Scarabeid beetle, cockroaches (e.g., Blatella germanica).

The “treatment location” refers to an area, region, article, animal, in which it is desired to reduce the target insect population. The treatment location may be an agricultural unit such as portion of land, a field or collection of fields, a vineyard, an orchard, a garden a green house, etc. The treatment location may also be a growing area of farmed animals such as a barn, a hen-house, a stable, a pasture, etc. The location may also be a container, a building, a house, a grain or crop storage, etc.

It should be noted that the insect control according to the invention, does not result in immediate decrease of the insect population but rather, by interfering with mating and reproductive patterns, results in a gradual decrease or much slower increase in the insect population, as would have otherwise occurred. Thus, it may be useful, at times, to combine the pest control by the use of an Acetyl-CoA carboxylase inhibitor, with another insecticidal agent, for example such that causes a relatively rapid decrease in the insect population. Such a combined treatment may require a lower amount of the other insecticide as would have normally been required or a less frequent use thereof.

According to an aspect of the invention the Acetyl-CoA carboxylase inhibitor may be applied in combination with an insect attractant. The insect attractant functions to lure the insects to the pesticide, thereby increasing the number of insects that come into contact with the insecticide. A composition according to this embodiment, which is novel per se and constitutes another aspect of the invention, thus includes Acetyl-CoA carboxylase inhibitor in combination with such an attractant. Contact of the insect with the composition may be of importance as in a suitable formulation, the Acetyl-CoA carboxylase inhibitor can be taken up by contact via the integument. The insect attractant may be a pheromone, a food source or a phagostimulant.

A suitable attractant formulation should, ideally, attract the insects from a distance, and should then also encourage sustained feeding once the insect was lured into the vicinity. For efficient luring the attractant may contain volatile components or may be included in a formulation that diffuses it into the environment. Preferably included, but not necessarily so, are also other component(s) that function as phagostimulants. Various volatile attractants have been reported in the literature and include, for example, aggregation pheromones or male pheromone that attracts the female to the insecticide site), which in most cases specific to a certain insect spices or at times for a wiser group of insects. Phagostimulants are in many cases insect non-specific (e.g., sucrose, protein hydrolysates and others).

Pheromone attractants are typically species-specific, so that each species' female is attracted to one specific insecticide-attractant formulation, rendering the combined insecticide/attractant formulation species-specific. An example of such an attractant is one selected from the group consisting of a 3,8-tetradecadienyl acetate, 3,11-tetradecadienyl acetate, 8,11-tetradecadienyl acetate, 3,8,11-tetradecatrienyl acetate and mixtures thereof.

Volatile attractants can be presented in a dispenser that release the attractant into the atmosphere in sustained manner, so as to exert an insect attracting effect over a prolonged time period One suitable dispenser is described in U.S. Pat. No. 4,834,745 to Ogawa et al., which is incorporated herein by reference.

Combination of attractants and insecticides in moth control compositions in sprays, on supports or in traps are disclosed in, for example, U.S. Pat. No. 5,236,715 to McDonough et al., which is also incorporated herein by reference.

In the combined use of an Acetyl-CoA carboxylase inhibitor and an attractant, the ingredients, while at times they may, do not have to be included in one formulation. For example the volatile attractant can be in one sort of slow release polymer or particulate material while the insecticide is in another or in a liquid dispenser.

The mode of administration of the Acetyl-CoA carboxylase inhibitor should be in accordance with its intended purpose and the nature of the location on which it is applied. For example, when the insecticides of the invention are applied to a region of plant growth (an agricultural crop, a garden etc) it is preferable to administer the inhibitor compounds such that they do not come into direct contact with the plant material, as the insecticide also adversely affect the plants. In such cases, localized administration modes (as opposed to spraying) in discrete spots in a treatment location are preferable, including, for examples: use of bait formulations comprising the inhibitor compounds and an attractant, which may, for example, be included in or on a carrier device or a trap; use of granular formulations or laminated slow release formulations; use of a carrier impregnated with the inhibitor compounds (and preferably also with an attracting agent), such as rubbers, plastics, silica, diatomaceous earth, and cellulose powder; use of nets, woven or not woven fibers, ribbons and particulate material of any size carrying in or on it an attractant and having on its surface the insecticide of the invention. The localized administration may also be by localized dispensers of liquid formulation containing the Acetyl-CoA carboxylase inhibitor.

Where a hazardous effect on plant growth is not of concern, (such as in farm animal management, in containers or storages) the compositions of the invention (at times together with an insect attracting agent) may be sprayed as aerosols or mists; applied as solution, dispersion, suspension or emulsion; or sprinkled over the desired location. In some cases, care should be taken not to apply such compositions directly on the animal.

The amount of active inhibitor used will be at least an effective amount. The term “effective amount,” as used herein, denotes an amount of eukaryotic-type Acetyl-CoA carboxylase inhibitor which is effective in controlling insect population in a treated location when compared to the same location if untreated. Of course, the precise amount needed may depend on the exact nature of the composition; the specific insect target, the nature of the treated location; the number of repeated treatments and on whether there is an accumulating effect; the environment, including weather or wind conditions; the time of year; etc.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic diagram showing the initial steps involved in fatty acid biosynthesis and the three key enzymes involved in the process; Acyl-CoA Synthase, ACCase (acetyl coenzymeA carboxylase) and FAS (fatty acid synthetase).

FIG. 2 shows the effect of addition of palmitoyl-CoA on the production of pheromone in pheromone producing cells in vitro in the presence of 0.01 μM Hez-PBAN (Helicoverpa zea-PBAN). The histograms demonstrate the incorporation of ¹⁴C (from ¹⁴C-acetate) in the presence of PBAN and in increasing concentrations of palmitoyl-CoA. The data represents the mean±SEM of at least 8 replicates. Different letters indicate a significant difference (Anova).

FIG. 3 shows the inhibitory effect of diclofop acid and diclofop methyl on the response to Hez-PBAN (0.05 μM) in vitro. Histograms depict the percentage of stimulation of de novo pheromone biosynthesis as a result of PBAN and in the presence of various concentrations of diclofop acid or diclofop methyl. The data represent the means±SEM of at least 47 replicates; different letters indicate a significant difference (Anova). The data were transformed to also show the level of inhibition at the various diclofop acid concentrations.

FIG. 4 shows the inhibitory effect of diclofop-methyl (several concentrations) on the response to various concentrations (pmol range) of Hez-PBAN in vitro. Points depict the incorporation of ¹⁴C into de novo pheromone biosynthesis as a result of the presence of PBAN. The data represents the mean±SEM.

FIG. 5 shows the inhibitory effect of tralkoxydim on the response to Hez-PBAN (0.01 μM) in vitro. The histograms depict ¹⁴C incorporation levels from ¹⁴C-acetate in control pheromone glands, as a result of Hez-PBAN, and in the presence of Hez-PBAN with various concentrations of tralkoxydim. The data represents the means±SEM of at least 6 replicates; different letters indicate a significant difference (Anova).

FIG. 6 shows the activity of ACCase enzyme in the presence of increasing concentrations of diclofop demonstrating the inhibitory effect of diclofop on the enzyme. Points depict the percentage of inhibition of ACCase activity compared to uninhibited levels which serve as a control.

FIG. 7 shows the effect of diclofop acid on pheromone production in vivo. Histograms depict means±SEM of at least 14 replicates showing pheromone levels, analysed by GC, obtained after injections of Hez-PBAN (1 pmol/female) in the presence or absence of diclofop (10 μmol/female). Different letters indicate a statistically significant difference (Anova).

FIG. 8 presents an elution profile showing relative levels of incorporation into pheromone component using HPLC separations of the hexane extractable products of pheromone glands after stimulation in vitro by Hez-PBAN in the presence or absence of diclofop acid.

### DETAILED DESCRIPTION OF THE INVENTION

As mentioned above, the present invention concerns pesticidal compositions comprising as their active component inhibitors of eukaryotic-type Acetyl-CoA carboxylase (ACCase) for effectively controlling pests. More specifically it relates to insecticidal compositions comprising inhibitors of ACCase. Such insecticides belong mainly to the known chemical families of aryloxyphenoxy propionates and cyclohexandione oximes. Mixtures of herbicides from these two families may also be applied. The aryloxyphenoxy propionates are selected from the group consisting of clodinafop-propargyl, clodinafop, cyhalofop-butyl, cyhalofop, diclofop-methyl, diclofop, fenoxaprop-P-ethyl, fenoxaprop, fluazifop-butyl, fluazifop-P-butyl, fluazifop, haloxyfop, propaquizafop, quizalofop, quizalofop-P or their mixtures. The cyclohexandione oximes are selected from the group consisting of alloxydim, BAS 625 H, butroxydim, clethodim, cycloxydim, sethoxydim, tepraloxydim, tralkoxydim or their mixtures.

Commercial, grass-selective herbicides specifically inhibit ACCase, which occurs in prokaryotic and eukaryotic forms in nature. The prokaryotic form (insensitive to 2-aryloxyphenoxypropionate herbicides) is composed of dissociable polypeptides, whereas the eukaryotic form is a homodimer of a multifunctional protein. In plants, dicotlyedons contain both types of enzyme, a eukaryotic form in the cytosol and a prokaryotic one in the plastids. However, grasses have enzymes of the eukaryotic type in both compartments² rendering the grasses sensitive to 2-aryloxyphenoxypropionate herbicides. In mammals, ACCase is a multifunctional polypeptide typical of the eukaryotic² ACCase type. A limited and reversible toxicity to field rodents has been observed in laboratory studies, which may be significant under chronic exposure. The inhibitory action of 2-aryloxyphenoxyproprionate herbicides on rat-liver ACCase may be attributed to conjugation of such inhibitors to CoA³. ACCase activity has been assayed in several insect species representing different orders, including the silkmoth, Bombyx mori⁴ but in all instances the emphasis has been on lipogenesis. Under field conditions, diclofop is relatively non-toxic to bees and to beneficial insects⁵. The commercial herbicide, diclofop-methyl itself does not pose a potential threat to the environment and diclofop acid, the active free acid hydrolyzed from the methyl ester, is regarded as even less toxic and less persistent in the environment than is the parent compound. Interference in ACCase activity is not taken into account in evaluations of environmental impact of 2-aryloxyphenoxyproprionate herbicides.

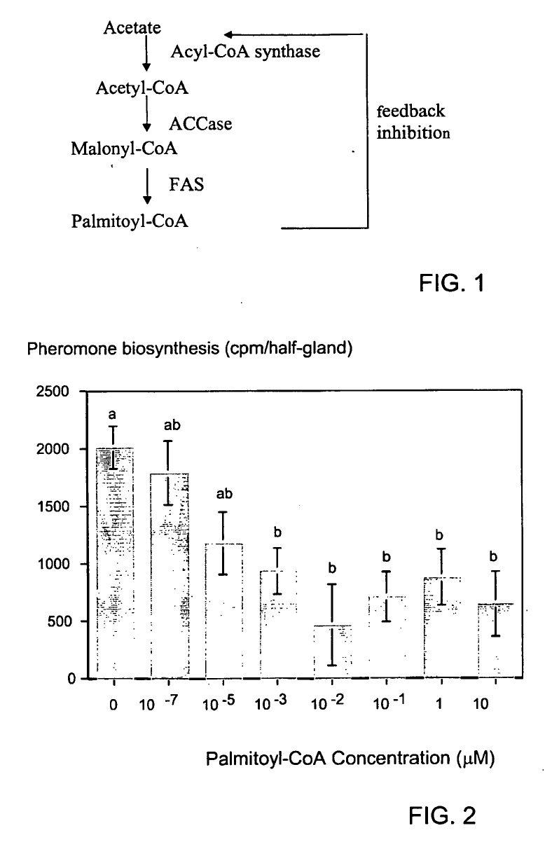

Mating receptivity in many insects is evidenced by production and timely release of a blend of species-specific female sex pheromones¹. Mating frequency and reproductive success of insects is frequently based on release of sex pheromones and co-specific attraction. Absence of pheromone production indicates that the female is sexually non-receptive. Many insect species utilize precursors of fatty acid biosynthesis for pheromone biosynthesis⁶. In nocturnal moths, female sex pheromones are controlled by the photoperiodic release of the neuropeptide Pheromone Biosynthesis Activating Neuropeptide (PBAN) into the insect blood system. They are produced in the pheromone gland, situated between the intersegmental membrane connecting the ultimate and penultimate abdominal segments of the female, and are derived from fatty acid precursors. The effect of PBAN on the different steps in the biosynthetic pathway has been investigated in several lepidopteran species but the key rate-limiting enzymes involved have not been conclusively established. From the available data¹ it appears that the rate-limiting step for PBAN may be either the initiation of fatty acid biosynthesis or the reduction of fatty acids. ACCase is a key enzyme in the initiation of fatty acid biosynthesis from precursor acetyl-CoA. FIG. 1 is a schematic diagram showing the initial steps involved in fatty acid biosynthesis and the three key enzymes involved, Acyl-CoA Synthase, ACCase (acetyl coenzyme A carboxylase) and FAS (fatty acid synthetase). In order to identify a possible rate-limiting step for the action of the PBAN in the process of producing pheromones, the incorporation of three possible precursors of various steps shown in FIG. 1 were measured in the presence and absence of PBAN. The selected precursors are ¹⁴C-acetate, ¹⁴C-acetyl-CoA and ³H-palmitic acid. The comparative results are shown in Table 1.

TABLE 1

Radio-label incorporation levels (cpm/half
gland) ± mean SEM

| | | PBAN stimulated |
|---|---|---|
| Precursor | Control | (0.01 μM) |
| ¹⁴C-acetate | 225 ± 31.2 (7) | 3809 ± 689 (9) |
| ¹⁴C-acetylCoA | 70 ± 16.8 (10) | 232 ± 27.8 (10) |
| ³H-palmitic acid | 3657 ± 1503 (3) | 4645 ± 2242 (3) |

Due to the low permeability rate of acetyl CoA, its levels of incorporation were significantly lower than those of the acetate; nevertheless, PBAN significantly increased the levels of incorporation of both acetylCoA and acetate into the pheromone. Addition of palmitic acid did not affect the pheromonotropic action of PBAN (data not shown). On the other hand, as shown in FIG. 1, palimitoyl-CoA is considered to be a feedback inhibitor of the ACCase activity and indeed as shown in FIG. 2, addition of palmitoyl-CoA affects the production of pheromone inhibiting its biosynthesis. Such an inhibition by palmitoyl-CoA indicates the importance of ACCase in PBAN induced pheromone production.

Two distinct assay systems were applied in order to determine the inhibition of PBAN-induced pheromone production, elicited by aryloxyphenoxy propionates and cyclohexandione oximes such as diclofop, diclofop-methyl and tralkoxydim. The first assay monitors de novo pheromone production by isolated pheromone glands in vitro according to the method of Rafaeli and Gileadi⁷ (Experimental Section). The second assay, monitors sex pheromone production in vivo by decapitated female moths that are incapable of pheromone production unless stimulated by PBAN (Experimental section).

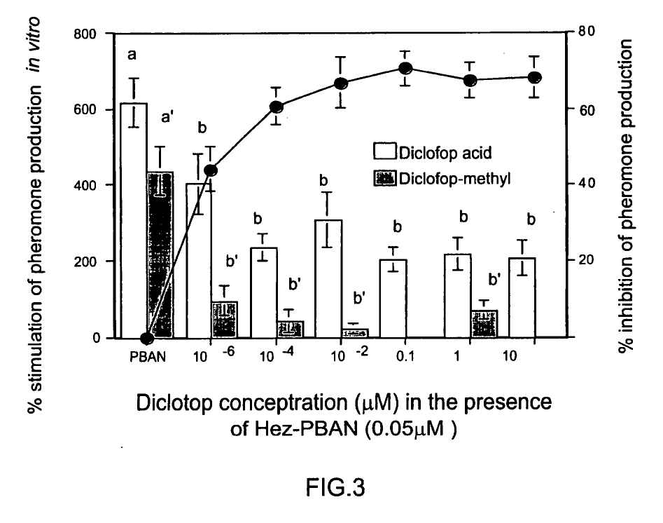

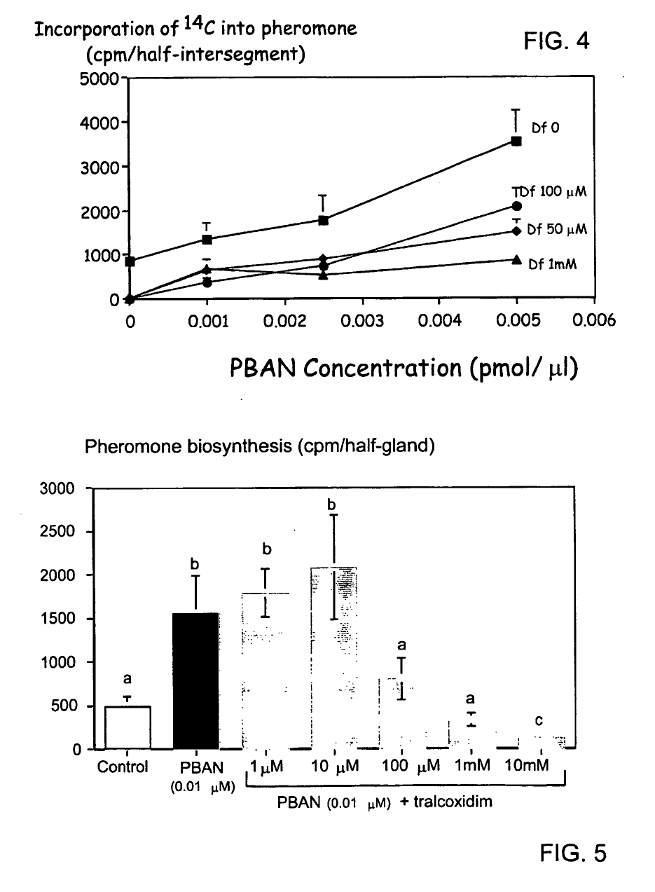

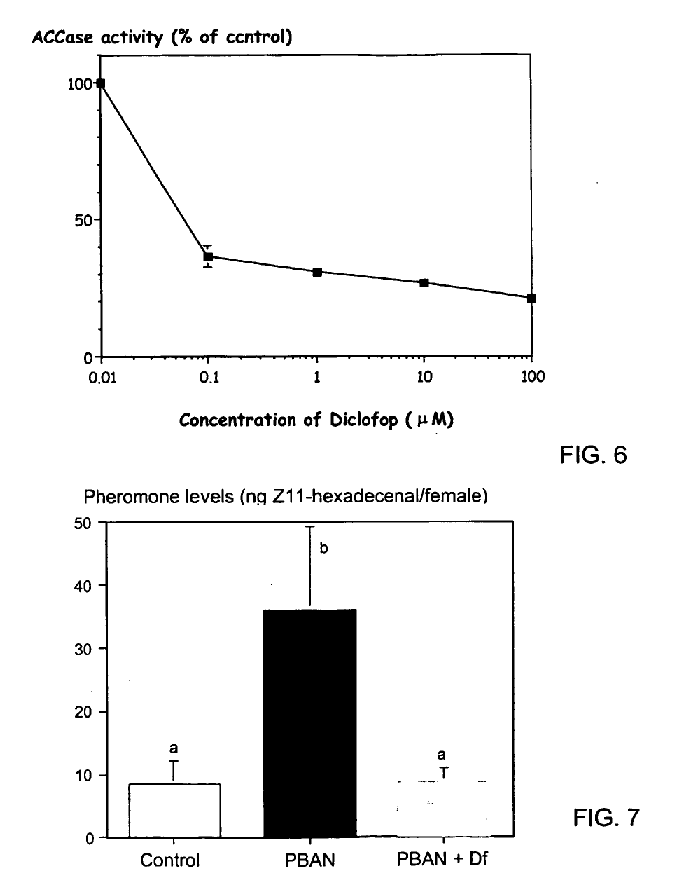

Turning to the in vitro experiments, diclofop acid, even at low concentrations in the μM range, significantly inhibits Hez-PBAN-activated sex pheromone production in the female moth H. armigera as shown in FIG. 3 where the Hez-PBAN concentration is 0.05 μM. The commercial herbicide, diclofop-methyl also significantly inhibits pheromone production to the same extent as the acid at the same range of concentration (μM) as demonstrated in FIG. 3. The effect of diclofop-methyl on in vitro pheromone production in the presence of varying concentrations of Hez-PBAN is shown in FIG. 4. Similar results of inhibition of pheromone production were found with tralkoxydim, a cyclohexanedione oxime herbicide known to affect the ACCase activity in monocotyledonous plants. The effect induced by tralkoxydim occurs at relatively higher concentrations, e.g. 100 μM as shown in FIG. 5 (Experimental Section). Turning to FIG. 6, the aryloxyphenoxy propionate diclofop acid may inhibit directly as measured on partially purified-enzyme activity in vitro from pheromone producing tissue demonstrating the sensitivity of the partially purified-enzyme to the herbicide.

Turning to FIG. 7 the effect of inhibition by diclofop acid of in vivo synthesis of pheromones induced by PBAN is given. Pheromone glands of decapitated female (Experimental section) were exposed to PBAN (1 pmol/female) thus producing the pheromone Z11-hexadecenal relative to the control where no PBAN is added to the glands. Addition of diclofop acid (Df) (10 μmol/female) to the PBAN-stimulated pheromone glands inhibited the production of the pheromone as evident by the fact that the pheromone levels are similar to those of the control.

### EXPERIMENTAL AND RESULTS

Insect Culture

General

Larvae of the noctuid moth Helicoverpa (Heliothis) armigera were reared in the laboratory on an artificial diet⁸ under a constant temperature of 26±1° C., 80% relative humidity and a 14 h/10 h (light/dark) non-diapause photoperiod. Pupae were sexed and separated, after which emerging male and female moths were collected in separate containers and fed 10% sugar water.

### Example 1

### Pheromone Biosynthesis and Its Inhibition by Diclofop and Tralkoxydim In Vitro

Intersegmental membranes (pheromone glands) between the eighth and ninth abdominal segments were removed from 2-3 day old virgin females. After 1 h preincubation in Pipes buffered incubation medium (pH 6.6), pheromone glands were dried on tissue paper and then transferred individually to 10 μl incubation medium containing 0.25 μCi [1-¹⁴C]-acetate (56 mCi/mmole, NEN, Boston, USA) in the presence or absence of Hez-PBAN (Peninsula Labs, Belmont, Calif., USA) and in the additional presence or absence of either diclofop acid or diclofop methyl ester (FIG. 3). The effect of tralkoxydim on the activity of H. armigera sex-pheromone glands is shown in FIG. 5. Tralkoxydim (1M) was dissolved in 100% MeOH and serially diluted (MeOH concentrations did not exceed 1%).

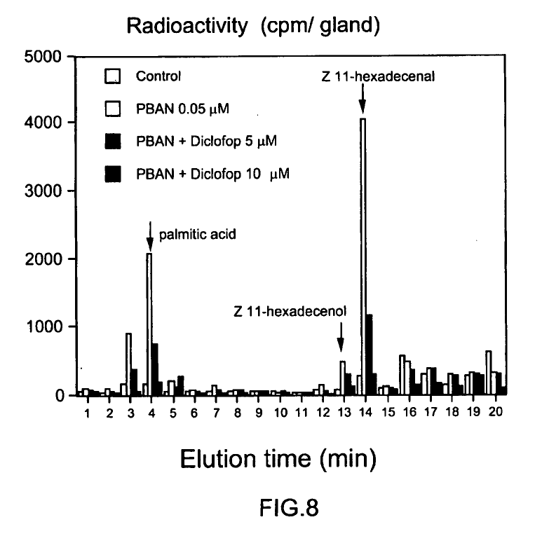

Incubations were performed for 3 h at room temperature. In order to measure the incorporation of radiolabel from [1-¹⁴C] sodium acetate, the glands were extracted in 200 μl hexane for 0.5 h at room temperature and a 100 μl aliquot of the upper hexane phase was measured in a β-counter. Relative levels of incorporation into the pheromone component were determined using HPLC analysis as reported previously⁹ using a Vydac C₁₈ reversed phase column and a linear gradient from 40-55% acetonitrile. Fractions were collected every minute and radioactivity determined. The radioactive elution profile (shown in FIG. 8) was compared to known elution times of standard palmitic acid, Z11-hexadecenol and the main pheromone product of H. armigera¹⁰, Z11-hexadecenal (Sigma, USA). In some experiments [1-¹⁴C]-acetyl CoA (Amersham Pharmacia Biotech, UK.) or [9, 10-³H]-palmitic acid (Life Science Products, Inc, Texas, USA) were substituted for [1-¹⁴C]-acetate in order to measure relative incorporation into pheromone from these precursors. The effect of palmitoyl CoA (Sigma) was also tested in a different set of experiments using [¹⁴C]-acetate as precursor (as shown in FIG. 2).

### Example 2

### Pheromone Biosynthesis and Its Inhibition by Diclofop In Vivo

In vivo sex pheromone production by female moths was determined in 2-day old females. The females were decapitated during the photophase of day 1 and subsequently maintained for an additional 24 h, after which they were injected with either physiological saline (control) or 1 pmol/moth Hez-PBAN in saline, and in the additional presence or absence of diclofop acid. Ovipositor tips (containing pheromone glands) were removed 2 h after injection and extracted for 10 min in hexane, containing 25 ng tridecanyl acetate (Sigma, USA) as internal standard. The hexane extract was concentrated to 2-3 μl final volume under a slow stream of N₂ and chromatographed on a 30 m SE-54 fused silica capillary column (internal diameter 0.25 mm) (Alltech, USA) in a Shimadzu HPLC gas chromatographic system. A temperature gradient was performed from initial 120° C. to 270° C. at 10° C./min, and kept for 15 min at the final temperature. The detector temperature was held at 280° C. and the column inlet at 300° C. Helium was used as a carrier at a flow pressure of 22 psi. Z11-hexadecenal was quantified using the internal standard quantification methods as described previously⁹.

### Example 3

### Inhibition of ACCase

The ACCase enzyme was extracted from pheromone glands separated on TMAE column and the eluted enzyme was used. Acetyl CoA was used as a substrate that requires HCO₃⁻ where radiolabeled HCO₃⁻ was used. In the presence of the enzyme, the substrate will be converted to radiolabeled malonyl CoA (see FIG. 1). Therefore, the difference in the level of incorporation of the radiolabeled malonyl CoA in the presence and absence of the ACCase enzyme was used to obtain the activity level of endogenous ACCase in the presence or absence of herbicides (FIG. 6).

### Example 4

### Formulating the Insecticide Composition

The inhibitors of the present invention are typically mixed with solid carriers, liquid carriers, gaseous carriers or baits, or absorbed into base materials, for example, porous ceramic plates or non-woven fabrics, added with surfactants and, if necessary, other additives, and then formulated into a variety of forms, for example, oil sprays, emulsified concentrates, wettable powders, well-flow granules, dusts, aerosols, fuming preparations such as fogging, evaporable preparations, smoking preparations, poisonous baits, and sheet or resin preparations.

Each of the above formulations may contain one or more of the inhibitors of the present invention as effective ingredients in an amount of 0.01 to 95% by weight.

The solid carriers usable in the formulations may include fine powders or granules of clays (e.g., kaolin clay, diatomaceous earth, bentonite, fubasami clay and acid clay), synthetic hydrated silicon oxide, tales, ceramics, other inorganic minerals (e.g., silicate, quartz, sulfur, active carbon, calcium carbonate and hydrated silica), and chemical fertilizers (e.g., ammonium sulfate, ammonium phosphate, ammonium nitrate, urea and ammonium chloride).

The liquid carriers may include water, alcohols (e.g., methanol, ethanol, etc.), ketones (e.g., acetone and methyl ethyl ketone), aromatic hydrocarbons (e.g., toluene, xylene, ethylbenzene and methylnaphthalene), aliphatic hydrocarbons (e.g., hexane, cyclohexane, kerosene and light oil), esters (e.g., ethyl acetate and butyl acetate), nitrites (e.g., acetonitrile and isobutyronitrile), ethers 2 5 (e.g., diisopropyl ether and dioxane), acid amides (e.g., N,N-dimethylformamide and N,N-dimethylacetamide), halogenated hydrocarbons (e.g., dichloromethane, trichloroethane and carbon tetrachloride), dimethyl sulfoxide, and vegetable oils (e.g., soybean oil and cottonseed oil).

The gas carriers or propellants may include Freon gas, butane gas, LPG (liquefied petroleum gas), dimethyl ether and carbon dioxide gas.

The base materials for the poisonous baits may include bait components (e.g., grain powders, vegetable oils, saccharides, and crystalline cellulose) antioxidants (e.g., dibutylhydroxytoluene and nordthydroguaiaretic acid), preservatives (e.g., dehydroacetic acid), agents for preventing children from eating poisonous baits by mistake (e.g., red pepper powders), and attractants (e.g. cheese perfume and onion perfume).

Examples of the surfactants may include alkyl sulfates, alkylsulfonates, alkylarylesulfonates, alkylaryl ethers and their polyoxyethylenated derivatives, polyethyleneglycol ethers, polyvalent alcohol esters and sugar alcohol derivatives.

Examples of the other auxiliaries such as adhesive agents and dispersants include casein; gelatin; polysaccharides such as starch, gum Arabic, cellulose derivatives and alginic acids lignin derivatives) bentonite; saccharides; and synthetic water-soluble polymers such as polyvinyl alcohol, polyvinylpyrrolidone and polyacrylic acids.

Further, stabilizers including PAP (isopropyl acid phosphate), BHT (2,6-di-tert-butyl-4-methylphenol), BHA (mixture of 2-tert-butyl-4-methoxyphenol and 3-tert-butyl-4-methoxyphenol), vegetable oils, mineral oils, surfactants, fatty acids and fatty acid esters can be utilized as formulation auxiliaries.

1. A method for controlling insects population in a desired location comprising applying to the location an effective amount of at least one inhibitor of eukaryotic-type Acetyl-CoA carboxylase.

2. A method according to claim 1 wherein said inhibitor is selected from arylphenoxypropionates in free acid form, ester form or salt form; cyclohexanedione oximes or salts thereof and mixtures of arylphenoxypropionate and cyclohexanedione oxime.

3. A method according to claim 2 wherein said arylphenoxypropionates are selected from: clodinafop-propargyl, clodinafop, cyhalofop-butyl, cyhalofop, diclofop-methyl, diclofop, fenoxaprop-P-ethyl, fenoxaprop, fluazifop-butyl, fluazifop-P-butyl, fluazifop, haloxyfop, propaquizafop, quizalofop, quizalofop-P and their mixtures.

4. A method according to claim 2 wherein said cyclohexanedione oximes are selected from alloxydim, BAS 625 H, butroxydim, clethodim, cycloxydim, sethoxydim, tepraloxydim, tralkoxydim.

5. A method according to claim 3, wherein said arylphenoxypropionate is diclofop acid or diclofop-methyl and said cyclohexanedione oxime is tralkoxydim.

6. A method according to claim 5 wherein the insects are characterized by having female sex pheromones that are fatty-acid derived.

7. A method according to claim 1 wherein the insects are of order Lepidoptera.

8. A method according to claim 1 further comprising applying at least one insect attracting agent to the location.

9. A method according to claim 8 wherein the insect attracting agent is a pheromone, food source or phagostimulant.

10. A method according to claim 9 wherein the pheromone is a pheromone for attracting insect females.

11. A method according to claim 1 wherein eukaryotic-type Acetyl-CoA carboxylase inhibitor is applied in discrete spots in a treatment location together with an attractant to lure the insects to said location.

12. A composition comprising at least one inhibitor of eukaryotic-type Acetyl-CoA carboxylase and at least one insect-attracting agent.

13. A composition according to claim 12 wherein said inhibitor is selected from arylphenoxypropionates in free acid form, ester form or salt form; cyclohexanedione oximes or salts thereof; and mixtures of arylphenoxypropionate and cyclohexanedione oxime.

14. A composition according to claim 12 wherein the insect attracting agent is a pheromone, food source or phagostimulant.

15. A composition according to claim 14 wherein the pheromone is a pheromone for attracting insect females.

16. A composition according to claim 12 adapted for localized administration in discrete spots in a treatment location.
